(19) United States
(12) Patent Application Publication
(10) Pub. No.: US 2011/0186672 A1
(43) Pub. Date: Aug. 4, 2011

(54) Device for Grinding A Biological Sample

(76) Inventor: Jean-Jacques Bougy, Garancieres (FR)

(21) Appl. No.: 12/808,443

(22) PCT Filed: Dec. 8, 2008
(86) PCT No.: PCT/FR08/01705

§ 371 Date: Apr. 18, 2011

(30) Foreign Application Priority Data
Dec. 18, 2007 (FR) 07/08835

(51) Int. Cl. B02C 1/00

(52) U.S. Cl. 241/277

(57) ABSTRACT

A device for grinding a biological sample, the device comprising a jar (14) closed by a stopper (26) fitted with a cutter-carrying shaft (36) and with a septum for passing a sample-taking needle, the device including means (12) for supporting and holding still the jar on the axis of an electric motor (20, 22) for driving the shaft (36) in rotation.

The invention relates to a device for grinding a sample of soft material, e.g. a biological sample, in particular a sample of relatively large volume.

Oscillating-tray grinders are known in which small-volume tubes carried by the tray and containing samples for grinding together with microbeads are subjected to intense alternating accelerations that achieve very effective grinding of the samples. Nevertheless, such tubes are limited in volume and weight, since the accelerations used do not allow loads of more than a few grams per tube to be exceeded.

Other known grinders are also limited to working volumes of less than 0.1 liters or 0.2 liters, and no grinders exist on the market that are capable of operating under the desired safety conditions with consumables having working volumes of 0.5 liters or more.

A particular object of the invention is to satisfy this need.

To this end, the invention provides a device for grinding a biological sample, the device being characterized in that it comprises means for supporting and holding still a jar for containing the sample and that is closed at its top end by a stopper provided with means for guiding a shaft in rotation, the shaft extending inside the jar and carrying cutter blades at its bottom end, the top end of the shaft being outside the stopper and including means for connection to rotary drive means carried by the jar support means.

In the device of the invention, the jar is a consumable that may be closed by the stopper immediately after the sample has been deposited therein and that is subsequently not opened again. To grind the sample, it suffices to connect the top end of the shaft mounted in the stopper of the jar to rotary drive means.

The sample is ground by the cutter blades mounted at the bottom end of the shaft.

According to another characteristic of the invention, the stopper of the jar includes a through passage having a septum mounted therein for passing a sample-taking needle.

The sample-taking needle, which may be mounted in the septum of the stopper after the sample has been ground and centrifuged, serves to suck up a certain quantity of supernatant, without it being necessary to open the jar or to manipulate the stopper for this purpose.

This limits any risk of the ground sample being contaminated by the ambient atmosphere and any risk of the surroundings being contaminated by the content of the jar, thereby ensuring maximum safety.

The jar and its contents are designed to be destroyed after the sample has been taken.

Advantageously, the rotary drive means for the shaft are movable on the support means for the jar between an inactive position in which they are separate from the shaft that is guided in the stopper, and an active position in which they are connected to said shaft in order to drive it in rotation. The stopper of the jar includes a through axial passage having respective smooth bearings mounted at both ends thereof to guide the shaft in rotation, the bottom end of the through passage being fitted with a sealing gasket that co-operates with the shaft, and the top end of the passage including an axial abutment for guiding the shaft.

The stopper fitted with the shaft and the septum is screwed onto the top end of the jar, which top end is received in an annular groove in the stopper with a sealing gasket mounted in the bottom of the groove.

According to another characteristic of the invention, the means for supporting the jar and holding it still comprise a lagged enclosure open at its top end and lined internally with a flexible cylindrical sleeve of shape complementary to that of the jar, the sleeve being connected to means for circulating a cold fluid under pressure.

The bottom of the enclosure is advantageously covered in a flexible cushion or disk for supporting the jar, the cushion or disk also being connected to means for circulating cold fluid under pressure.

The jar is thus supported in a manner that enables vibration to be damped and that ensures that the jar and its content is maintained at a desired temperature.

The invention also provides a jar for a grinder device of the above-described type, the jar being characterized in that it includes a closure stopper formed with a first through passage fitted with bearings for guiding a blade-carrier shaft and with a second through passage fitted with a septum for passing a sample-taking needle.

The jar is preferably made of a translucent or transparent plastics material such as polypropylene or polyethylene, and has a volume lying in the range 0.2 liters to 1.5 liters.

The invention can be better understood and other characteristics, details, and advantages thereof appear more clearly on reading the following description made by way of example with reference to the accompanying drawings, in which:

FIG. 1 is a diagrammatic axial section view of a grinder device of the invention;

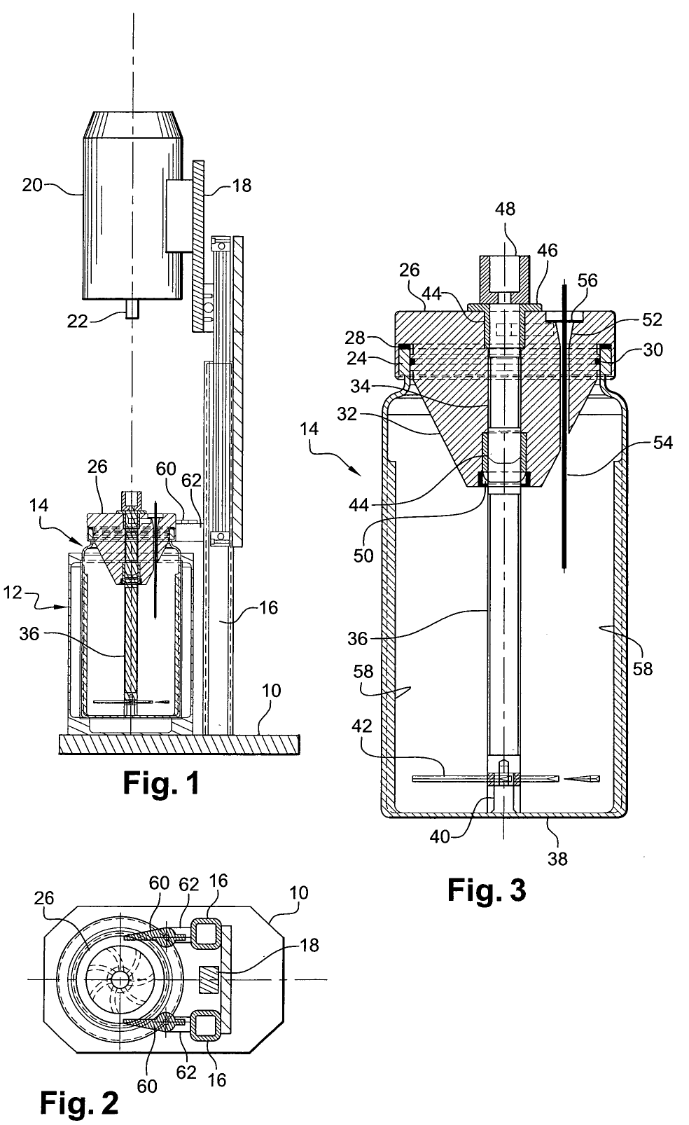

FIG. 2 is a cross-section view of the device;

FIG. 3 is an axial section view on a larger scale showing a jar of the invention; and

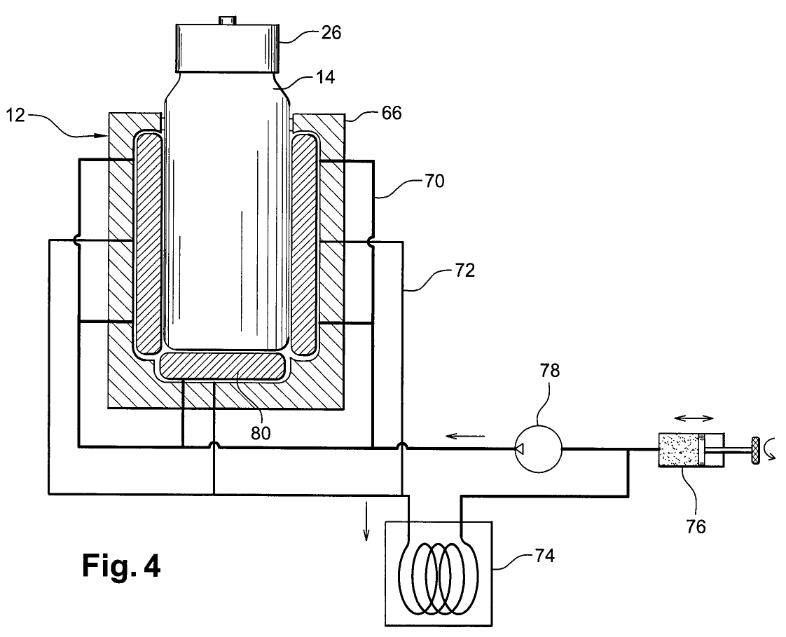

FIG. 4 is a diagram showing means for supporting and maintaining the temperature of the jar of the invention.

The device shown in FIG. 1 essentially comprises a base plate 10 carrying means 12 for supporting and holding still a jar 14 for containing a sample that is to be ground, the plate 10 also carrying two vertical uprights 16 for supporting means 18 for guiding an electric motor 20 in translation, the vertical outlet shaft 22 of the motor being placed above the jar 14 and pointing towards it.

As can be seen better in FIG. 3, the jar 14 is a cylindrical container of transparent or translucent plastics material, such as polypropylene or polyethylene, for example, it has a volume of about 1 liter in the example shown, and it is of shape and volume that are compatible with a pod of a centrifuge. The threaded top end 24 of the jar is received in a peripheral annular groove of a stopper 26 that is likewise preferably made of a plastics material such as polyethylene or polypropylene.

The outer cylindrical wall of the annular groove of the stopper 26 is threaded to enable the stopper to be screwed onto the jar, a sealing gasket 28 being placed in the bottom of the groove so as to be compressed by the top end of the jar when the stopper 26 is fully screwed onto the jar.

This closure is also sealed by another sealing gasket 30 that is mounted in an annular slot in the inside cylindrical wall of the annular groove of the stopper, the gasket 30 co-operating with the inside cylindrical face of the top end 24 of the jar.

As shown, the stopper 26 may include a frustoconical central bottom portion 32 that is designed to extend inside the jar 14 over a certain length and that includes a through axial passage 34 that has a shaft 36 mounted and guiding therein to extend to the vicinity of the bottom 38 of the jar 14, and that may be centered on a cylindrical stud 40 projecting from the bottom of the jar.

The bottom end of the shaft 36 includes cutter blades 42 of conventional type, which blades are curved as circular arcs, for example.

The top portion of the shaft 36 is guided in rotation in the passage 34 by means of two smooth bearings 44 mounted at the ends of said passage and by means of an axial abutment 46 mounted at the top end of the passage 34.

The top end of the shaft 36, lying outside the stopper 26, carries an endpiece 48 for connection with the outlet shaft 22 of the electric motor 20.

A sealing gasket 50 is mounted at the bottom end of the passage 34, under the smooth bearing 44 and co-operating with the cylindrical surface of the shaft 36.

Another through passage 52 is formed in the stopper 26, parallel to the axial passage 34 in order to receive a sample-taking needle 54 having its bottom end lying at a certain distance inside the jar 14, said needle 54 passing in leaktight manner through a septum 56 mounted in the enlarged top end of the passage 52.

Vertical splines 58 project from the inside vertical surface of the jar 14 to oppose rotation of the sample inside the jar while it is being ground.

The grinder device of the invention also has two tabs or clips 60 for centering the jar 14 on the axis of the shaft 22 of the motor 20, these tabs or clips 60 being mounted to pivot on horizontal arms 62 carried by the vertical uprights 16 so that their free ends come to bear against or engage two diametrically opposite points of the periphery of the stopper 26, as shown diagrammatically in FIG. 2, thereby holding the stopper 26 and the jar on the axis of the shaft of the motor 20.

The means 12 for supporting the jar 14 and holding it still are shown in greater detail in FIG. 4, and essentially they comprise a lagged enclosure 66 made of a thermally insulating material, with an open top end through which the jar 14 can be inserted, and containing a cylindrical sleeve 68 of flexible material extending over substantially the full height of the enclosure 66 and of the jar 14, the sleeve 68 being connected to a feed circuit 70 and a return circuit 72 for a cold fluid under pressure, which circuits are connected to means 74 for cooling the fluid, the feed circuit 70 having means 76 for pressurizing the fluid and for compensating expansion, together with a pump 78 for driving circulation of the fluid.

An inflatable circular disk or cushion 80 is mounted on the bottom of the enclosure 66 to support the bottom of the jar 14 and it is also connected to the feed and return circuits 70 and 72 for the cold fluid.

The sleeve 68 is dimensioned so as to bear narrowly against the cylindrical wall of the jar 14 and against the inside wall of the enclosure 66 when it is full of fluid under pressure, thereby ensuring good heat transfer between the cold fluid and the jar 14, and also serving to hold the jar 14 firmly in the enclosure 66 and to damp vibration.

Typically, the cooling fluid used is water and it enables the temperature of the biological sample being ground in the jar 14 to be maintained at a value of a few degrees centigrade above or below zero. The device 76 for applying pressure and compensating expansions is a very simple mechanical device as shown diagrammatically in FIG. 4, e.g. of the type having a screw or a rod with a piston.

The grinder device of the invention is used as follows:

Each jar 14 is provided packaged in sterile packaging and fitted with a stopper 26 carrying a blade-carrier shaft 36 and a septum 56.

In order to use it, it suffices to open the sterile packaging, unscrew the stopper 26, place the biological sample for grinding in the jar 14, and put the stopper 26 back into place, screwing it home onto the threaded end of the jar 14.

By way of example, the biological sample for grinding may be a chicken embryo having a virus inoculated therein for the purpose of developing antibodies that are to be extracted after grinding and centrifuging.

After the stopper 26 has been screwed onto the jar, the jar is placed in the enclosure 66 of the means 12 for supporting the jar and holding it still, the clips 60 are closed onto the stopper 26, the motor 20 is lowered towards the jar to engage the end of the shaft 22 in the endpiece 48 of the stopper, and the motor 20 is powered to drive the blades 42 carried by the shaft 36 in rotation, with the speed of rotation of the shaft lying typically in the range 6000 revolutions per minute (rpm) to 12,000 rpm. The duration of grinding may vary over the range a few seconds to a few minutes, depending on circumstances.

The temperature of the sample is kept below 8° C. or 10° C. by circulating a cold liquid in the sleeve 68 and in the cushion 80.

After grinding, the jar 14 closed by the stopper 26 is placed in a centrifuge to separate the solid from the supernatant inside the jar. The needle 54 introduced into the jar through the septum 56 in the stopper 26 serves to take a certain quantity of the supernatant from the jar 14.

Thereafter, the jar 14, still closed by its stopper 26 fitted with the shaft 36, is put aside for destruction.

The device of the invention presents certain significant advantages compared with the present technique:
it uses grinder technology that has stood the test of time and that gives satisfaction;
it guarantees total asepsis;
all of the intermediate operations of transferring, cleaning, sterilizing, and packaging that are performed in the prior art are eliminated;
it is simple for operators to use without raising any problems; and
the volume of the jar 14 may be determined at will to lie in the range 0.1 liters or 0.2 liters to 1.5 liters or 2 liters, in particular.

1. A device for grinding a biological sample, the device being characterized in that it comprises means for supporting and holding still a jar for containing the sample and that is closed at its top end by a stopper provided with means for guiding a shaft in rotation, the shaft extending inside the jar and carrying cutter blades at its bottom end, the top end of the shaft being outside the stopper and including means for connection to rotary drive means carried by the jar support means.

2. A device according to claim 1, wherein the rotary drive means are movable on the support means between an inactive position in which they are separated from the shaft guided in the stopper of the jar, and an active position in which they are connected to said shaft in order to drive it in rotation.

3. A device according to claim 1, wherein the stopper of the jar includes a through axial passage with respective smooth bearings being mounted at both ends thereof to guide the shaft in rotation.

4. A device according to claim 3, wherein the bottom end of the through passage is fitted with a sealing gasket co-operating with the shaft.

5. A device according to claim 3, wherein the top end of the through passage includes an axial abutment for guiding the shaft.

6. A device according to claim 3, wherein the stopper includes a second through passage in which a septum is mounted for passing a sample-taking needle.

7. A device according to claim 1, wherein the stopper is screwed onto the threaded top end of the jar.

8. A device according to claim 1, wherein the means for supporting the jar and holding it still comprise an enclosure open at its top end and lined internally with a flexible cylindrical sleeve of shape complementary to that of the jar, the sleeve being connected to means for circulating a cold fluid under pressure.

9. A device according to claim 8, wherein the bottom of the enclosure is covered in a flexible cushion or disk for supporting the jar, the cushion or disk being connected to the means for circulating a cold fluid under pressure.

10. A device according to claim 1, characterized in that it including pivoting tab means for centering the jar and the stopper relative to the means for driving the shaft in rotation.

11. A jar for a grinder device according to claim 1, the jar including a closure stopper formed with a first through passage having bearings for guiding a cutter-carrying shaft, and with a second through passage fitted with a septum.

12. A jar according to claim 11, and being made of a translucent or transparent plastics material such as polypropylene or polyethylene, with a volume lying in the range 0.2 liters to 1.5 liters.
